(19) United States
(12) Patent Application Publication
(10) Pub. No.: US 2024/0425661 A1
(43) Pub. Date: Dec. 26, 2024

(54) FOAMING POLYMERIC MATERIALS

(71) Applicant: Adaptive 3D Technologies, LLC, Plano, TX (US)

(72) Inventors: Benjamin LUND, Wylie, TX (US); Carlos A. BARRIOS, Frisco, TX (US); Xun HAN, Dallas, TX (US); Guangzhe GAO, Plano, TX (US); Seyed Mahmoud HOSSEINI, Dallas, TX (US); Dhruv NARAYANAN, Tyler, TX (US); Walter VOIT, Dallas, TX (US); Stephen KAY, Georgetown, TX (US); Nathan BLANCO, Plano, TX (US)

(73) Assignee: Adaptive 3D Technologies, LLC, Plano, TX (US)

(21) Appl. No.: 18/690,376

(22) PCT Filed: Sep. 9, 2022
(86) PCT No.: PCT/US2022/043151

§ 371 Date: Mar. 8, 2024

Related U.S. Application Data
(60) Provisional application No. 63/242,999, filed on Sep. 10, 2021.

(51) Int. Cl. C08J 9/32; C08J 9/18

(52) U.S. Cl. CPC C08J 9/32; C08J 9/18; C08J 2201/00; C08J 2203/22; C08J 2385/02

(57) ABSTRACT

The present disclosure relates to photo-polymerizable resins, methods of photo-polymerizing and foaming resins, and foamed polymeric materials. Some disclosed resins comprise: a first monomer; a second monomer; a photo-activated polymerization catalyst; and a thermally activated foaming agent. Some disclosed methods of preparing photo-polymerized and foamed materials comprise photo-polymerizing a resin with a thermally activated foaming agent to obtain a photo-polymerized polymer material; and heating the photo-polymerized polymer material at a heating temperature to obtain the photo-polymerized and foamed polymer material, wherein the thermally activated foaming agent has a foaming onset temperature, and the heating temperature is greater than or equal to the foaming onset temperature. Also disclosed are photo-polymerized and foamed materials. Further disclosed are polymeric structures having a foam.

### CROSS-REFERENCE TO RELATED APPLICATIONS

This application claims the benefit of priority to U.S. Provisional Application No. 63/242,999, filed Sep. 10, 2021, the entire content of which is hereby incorporated by reference.

### TECHNICAL FIELD

The present disclosure relates to photo-polymerizable resins, methods of photo-polymerizing and foaming resins, and foamed polymeric materials. Additionally, the disclosure relates to compositions and methods for obtaining printed, foamed articles using three-dimensional printing and other printing techniques.

### BACKGROUND

Additive manufacturing is a manufacturing technique that may reduce the time and overhead required to go from design to manufacturing. Other manufacturing technologies, such as injection and blow molding, may not be able to provide the direct design-to-manufacture advantages that 3D printing enables, and these other manufacturing technologies may have inherent limitations in manufacturing complex structures.

Foaming may lower a material's weight, improve softness/cushioning, and enhance insulative ability. Foaming may be done within a constrained space (such as a mold) or in an unconstrained manner (such as a spray-on foam).

Some foaming processes in additive manufacturing may foam resins before printing, thereby printing bubbles. In other foaming processes, parts may be foamed after printing using, e.g., a multi-step process where a physical blowing agent is added after printing. Such foaming processes are limited in the types of materials that may be made and may require uneconomically complex processing.

Accordingly, there is a need to improve material capabilities, costs, and manufacturing speed associated with foaming processes in additive manufacturing. There is a need for foamed, high-performance, elastomeric materials at a lower cost and improved manufacturing utilization. There is a need for foamed polymer materials having improved performance and weighting for various consumer applications such as footwear, bedding, safety equipment, cushioning, etc. There is a need for foamed polymer materials having complex designs that are lightweight and have desirable mechanical properties in, for example, the automotive and aerospace industries, where every pound eliminated reduces fuel consumption and/or increases the mile-per-charge on, e.g., an electric vehicle.

Furthermore, there is a need to print larger structures; however, additive manufacturing may be limited by printer size and/or build volume. Foaming a 3D printed part after printing allows one to print “outside of the box” (i.e., build volume). This means that a pair of shoes that would have required a $250K printer (with a large build volume) can be printed on a $20K printer (with a build volume that would otherwise be far too small to print the actual shoes). This also means that parts (such as mattresses, pillows, seat cushions, etc.) that could not be printed within conventional build volumes can be produced by additive manufacturing. For example, there is a need to be able to print large structures, such as those more than 300 mm×400 mm×400 mm, and subsequently expand them into still larger structures approaching or exceeding 1 m×1 m×1 m.

### SUMMARY OF INVENTION

The present disclosure relates to photo-polymerizable resins, methods of photo-polymerizing and foaming resins, and foamed polymeric materials.

In certain embodiments, the invention includes a resin, comprising: a first monomer; a second monomer; a photo-activated polymerization catalyst; and a thermally activated foaming agent. In certain embodiments, the thermally activated foaming agent has a density within 20% of the density of the resin.

In certain embodiments, the invention includes a method of preparing a photo-polymerized and foamed polymer material, the method comprising: photo-polymerizing a resin comprising a first monomer, a second monomer, a photo-activated polymerization catalyst, and a thermally activated foaming agent to obtain a photo-polymerized polymer material; and heating the photo-polymerized polymer material at a heating temperature to obtain the photo-polymerized and foamed polymer material, wherein the thermally activated foaming agent has a foaming onset temperature, and the heating temperature is greater than or equal to the foaming onset temperature.

In certain embodiments, the invention includes a photo-polymerized and foamed polymer material formed according to the above-described method.

In certain embodiments, the invention includes a polymeric structure having a macroscopic network geometry, wherein the macroscopic network geometry comprises a plurality of polymer links, each polymer link being joined to two or more polymer links, and wherein each polymer link comprises a foam.

In certain embodiments, the invention includes a resin, comprising: from about 3 pph to about 10 pph of a first monomer; 100 pph of a second monomer; from about 0.9 pph to about 2.1 pph of a photo-activated polymerization catalyst; and from about 5 pph to about 30 pph of a thermally activated foaming agent, wherein the first monomer comprises two or more thiol groups, wherein the second monomer comprises at least one of a methacrylate group, an acrylate group, or an acrylamide group, and wherein pph is parts by mass per hundred parts of total mass of methacrylate, acrylate, and acrylamide compounds in the resin. In certain embodiments, the resin further comprises at least one of an inhibitor, a dye, or an additive. In certain embodiments, the resin comprises from about 3 pph to about 8 pph of the first monomer; from about 1 pph to about 1.5 pph of the photo-activated polymerization catalyst; and from about 5 pph to about 30 pph of the thermally activated foaming agent. In certain embodiments, the resin comprises from about 5 pph to about 10 pph of the first monomer; from about 1 pph to about 1.5 pph of the photo-activated polymerization catalyst; from about 10 pph to about 25 pph of the thermally activated foaming agent; and from about 0.1 pph to about 0.4 pph of an inhibitor. In certain embodiments, the resin comprises from about 4.3 pph to about 8.5 pph of the first monomer; from about 0.9 pph to about 2.1 pph of the photo-activated polymerization catalyst; from about 17.4 pph to about 25 pph of the thermally activated foaming agent; and from about 0.1 pph to about 0.5 pph of an inhibitor.

### BRIEF DESCRIPTION OF DRAWINGS

FIG. 1 depicts an exemplary process in which a photo-polymerized polymer material (101) is heated (102) to obtain a photo-polymerized and foamed polymer material (103).

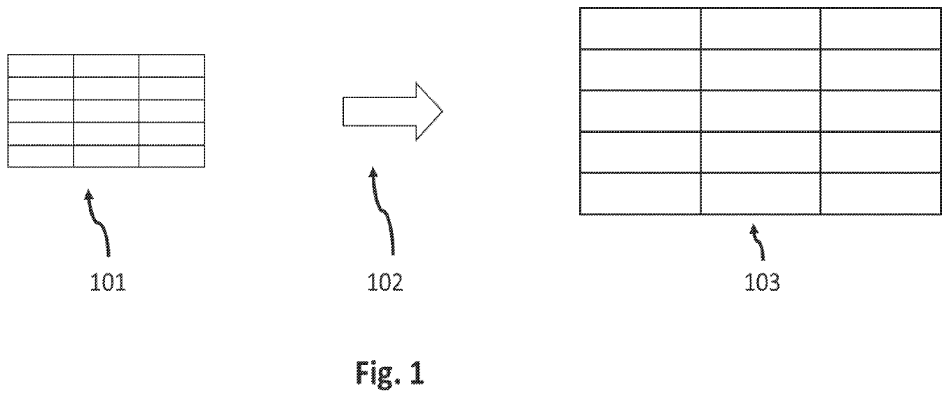

FIG. 2 depicts an exemplary photo-polymerized polymer material before (201) and after (202) foaming.

FIG. 3 depicts an exemplary photo-polymerized polymer material before (301) and after (302) foaming.

FIG. 4 depicts an exemplary photo-polymerized polymer material before (401) and after (402) foaming.

FIG. 5 depicts an image of an exemplary photo-polymerized and foamed polymer material rendered using scanning electron microscopy (SEM).

FIG. 6 depicts the results of Dynamic Mechanical Analysis performed on a photo-polymerized polymer material formed from an exemplary resin sample, as disclosed herein.

FIG. 7 depicts the results of Dynamic Mechanical Analysis performed on a photo-polymerized polymer material formed from an exemplary resin sample, as disclosed herein.

FIG. 8 depicts the results of Dynamic Mechanical Analysis performed on a photo-polymerized polymer material formed from an exemplary resin sample, as disclosed herein.

FIG. 9 depicts the results of Dynamic Mechanical Analysis performed on a photo-polymerized polymer material formed from an exemplary resin sample, as disclosed herein.

FIG. 10 depicts the results of Dynamic Mechanical Analysis performed on a photo-polymerized polymer material formed from a control resin sample, as disclosed herein.

### DETAILED DESCRIPTION

The ability to print larger structures through additive manufacturing processes may be accomplished by reducing the weight of a given size part by foaming and expanding that part through the addition of expandable polymeric microspheres. In some embodiments, a photo-polymerized material may be foamed by suspending microspheres in a 3D-printable polymer resin, printing a part from the resin using a 3D printing lithography process, and, once printed, heating the part to expand the microspheres, which in turn may expand the part to the desired size and density. In some embodiments, the size and density of the part may be controlled by controlling the ratio of the microspheres to other components within the resin, and the expansion dynamics of the part may be controlled by controlling the heating process.

The inclusion of microspheres may enable the development of new and previously unobtainable foamed design parts and structures. In some embodiments, microspheres may also enable the user to print parts on a much smaller scale and expand the part during the heating process. Printing the parts at sizes smaller than their “foamed” versions may greatly increase the throughput and utilization of the equipment producing the parts. In some embodiments, producing a smaller printed part may reduce space used in the x, y, and z directions, improving not only space utilization on a printer, but also reducing print time, as the height of the part (i.e., its size in the z direction) may influence print speed.

Consequently, in some embodiments, foaming may enable the use of less expensive processing equipment with smaller footprints and increase throughput per square foot of factory space, driving down costs and intrinsically increasing the cost advantages of using ETR-X foams over traditional foams.

### Additional Disclosures Incorporated by Reference

Each of the following disclosures is incorporated by reference in its entirety: PCT Publication No. WO 2019/191509 A1, PCT Publication No. WO 2019/204770 A1, PCT Publication No. WO 2020/154703 A1, and PCT Publication No. WO 2021/016481 A1.

### Photo-Polymerizable and Foamable Polymer Resins

In some embodiments, a resin capable of being photo-polymerized and foamed into a foamed polymeric structure may be provided.

A printed part may comprise an elastomeric resin with expandable, closed cell microspheres. In some embodiments, a resin may be 3D printable, and its expansion may be controlled through structural design.

In some embodiments, a printed part may be formed from a photo-polymerizable polymer resin comprising a first monomer and a second monomer.

In some embodiments, the first monomer may comprise two or more thiol groups. In some embodiments, the first monomer may comprise one or more of the thiol compounds disclosed in PCT Publication Nos. WO 2019/191509 A1, WO 2019/2040770 A1, WO 2020/154703 A1, and WO 2021/016481 A1.

In some embodiments, the first monomer may comprise at least one of 2,2′-(ethylenedioxy) diethanethiol (EDDT), 1,4-bis(3-mercaptobutyryloxy) butane (BD1), pentaerythritol tetrakis(3-mercaptobutylate) (PE1), or 1,3,5,-tris(3-mercaptobutyryloxyethyl)-1,3,5,-triazine-2,4,6 (1H,3H,5H)-trione (CAS 928339-75-7) (NR1).

In some embodiments, the second monomer may comprise two or more isocyanate groups. In some embodiments, the second monomer may comprise one or more of the isocyanate compounds disclosed in PCT Publication Nos. WO 2019/204770 A1 and WO 2020/154703 A1.

In some embodiments, the resin may comprise from 1 weight % to 20 weight % of the first monomer; from 1 weight % to 99 weight % of the second monomer; a photo-activated polymerization catalyst; and a thermally activated foaming agent, wherein the first monomer comprises at least one thiol, the second monomer comprises at least one isocyanate, and the weight % is by total weight of the resin. In some cases, the resin may include the first monomer and the second monomer in about a stoichiometric ratio. In some embodiments, the first monomer may compose less than about 20%, less than about 10%, or less than about 5% by weight of the resin.

In some embodiments, the second monomer may comprise at least two double carbon-carbon bonds, at least two triple carbon-carbon bonds, or at least one each of a double carbon-carbon bond and a triple carbon-carbon bond.

In some embodiments, the second monomer may comprise at least one methacrylate group. In some embodiments, the second monomer may comprise two or more methacrylate groups. In some embodiments, the second monomer may comprise at least one of isobornyl methacrylate (IBOMA), tert-butyl methacrylate (TBMA), 2-ethylhexyl methacrylate (EHMA), isodecyl methacrylate (IDMA), 2-hydroxyethyl methacrylate (2-HEMA), lauryl methacrylate, or trimethylolpropane trimethacrylate (TMPTMA).

In some embodiments, the second monomer may comprise at least one acrylate group. In some embodiments, the second monomer may comprise two or more acrylate groups. In some embodiments, the second monomer may comprise at least one of isobornyl acrylate (IBOA); 2-ethylhexyl acrylate (EHA); cyclic trimethylolpropane formal acrylate; hydroxypropyl acrylate (mixture of isomers) (HPA); poly(propylene glycol) diacrylate (PPGDA); tricyclodecanedimethanol diacrylate (tricyclo[5.2.1.0 2,6]decanedimethanol diacrylate) (TCDA); trimethylolpropane triacrylate (TMPTA), tri (propylene glycol) diacrylate (mixture of isomers) (TPGDA); poly(ethylene glycol) diacrylate (PEGDA); siloxanes and silicones, di-me,3-[2-(hydroxy-3-[(1-oxo-2-propenyl)oxy]propoxy]propyl group-terminated (e.g., Silmer® OH ACR Di-400); a urethane acrylate oligomer (e.g., Sartomer® CN1966); an aliphatic urethane acrylate oligomer (e.g., Sartomer® CN9002); an aliphatic urethane acrylate oligomer (e.g., Sartomer® CN9004); an aliphatic urethane acrylate oligomer (e.g., Sartomer® CN9028); an aliphatic urethane acrylate oligomer (e.g., Sartomer® CN9070); or an aromatic urethane acrylate oligomer (e.g., Sartomer® CN9782).

In some embodiments, the second monomer may comprise at least one acrylamide. In some embodiments, the second monomer may comprise N, N′-methylenebis(acrylamide).

In some embodiments, the first monomer may comprise an oligomer. In some embodiments, the second monomer may comprise an oligomer. In some embodiments, the resin may further comprise an oligomer.

In some embodiments, the second monomer may comprise a crosslinking agent.

The resin may comprise a photo-activated polymerization catalyst. The photo-activated polymerization catalyst may be any compound that undergoes a photoreaction on absorption of light to produce a polymerization initiator (e.g., a reactive free radical, a base, or an acid). Therefore, photo-activated polymerization catalysts may be capable of initiating or catalyzing chemical reactions, such as free radical polymerization. In some embodiments, the photo-activated polymerization catalyst may comprise a radical-generating compound. In some embodiments, the photo-activated polymerization catalyst may comprise at least one of diphenyl(2,4,6-trimethylbenzoyl) phosphine oxide (TPO) or phenylbis(2,4,6-trimethylbenzoyl) phosphine oxide (CAS 162881-26-7) (BAPO). In some embodiments, the photo-activated polymerization catalyst may comprise a non-nucleophilic photo-base.

The resin may comprise a foaming agent. In some embodiments, the foaming agent may comprise at least one microsphere comprising volatile, low molecular weight hydrocarbons encapsulated within a polymer plastic shell. In some embodiments, the foaming agent may be thermally activated. In some embodiments, the foaming agent may comprise at least one expandable microsphere. In some embodiments, the foaming agent may comprise at least one heat-expandable microsphere. In some embodiments, the thermally activated foaming agent may comprise Sekisui ADVANCELL EML 101 or Sekisui ADVANCELL EM 504.

Microsphere load in a resin may not be particularly limited. In some embodiments, the microspheres may blend and co-exist within the resin. In some embodiments, the microsphere load may be configured to enable sufficient foaming and/or expansion without drastically inhibiting or excessively diffracting ultraviolet (UV) light during the photo-polymerization process.

A specific amount of foaming of the photo-polymerized polymer material produced from the resin may be achieved by tuning the amount of foaming agent in the resin. In some embodiments, including additional foaming agent increases the amount of foaming. In some embodiments, including less foaming agent decreases the amount of foaming.

In some embodiments, the foaming agent may be dispersed in the resin. In some embodiments, the density of the resin and the density of the foaming agent may be within 20%, within 15%, within 10%, within 5%, or within 1% of each other. In some embodiments, the density of the resin may be about the same as the density of the foaming agent. In some embodiments, the foaming agent may not sink in the resin. In some embodiments, the foaming agent may not float on the resin. In some embodiments, ambient temperature may maintain a stable dispersion of the foaming agent in the resin. In some embodiments, the foaming agent may be stably dispersed in the resin for at least two months, at least six months, at least one year, at least two years, or at least three years.

In some embodiments, the resin may have a density ranging from 0.8 g/cm³ to 1.5 g/cm³ as a liquid. In some embodiments, the resin may have a density ranging from 1.1 g/cm³ to 1.5 g/cm³ as a liquid. In some embodiments, the resin may be 3D-printed using Digital Light Processing (DLP), stereolithography (SLA), etc., to generate at least one solid part with a density of 1.1 g/cm³ to 1.5 g/cm³ and may be thermally treated to generate at least one foamed part with a density of 0.4 g/cm³ to 0.6 g/cm³. In some embodiments, the thermally activated foaming agent may have a density ranging from 1 g/cm³ to 1.2 g/cm³.

In some embodiments, the resin may comprise an inhibitor. The inhibitor may be any compound that terminates a propagating polymer chain. For example, the inhibitor may be any compound that reacts with free radicals to give products that may not be able to induce further polymerization. In some embodiments, the inhibitor may comprise at least one of butylated hydroxytoluene (BHT), pentaerythritol tetrakis(3,5-di-tert-butyl-4-hydroxyhydrocinnamate) (e.g., IRGANOX 1010), hydroquinone (HQ), 2-methoxyhydroquinone (MHQ), 1,3-diallyl-2-thiourea, or 2,2′-diallyl bisphenol A.

In some embodiments, a mixed metal oxide or dye may be added to the resin, e.g., to obtain a colored part after photo-polymerization and foaming. In some embodiments, the mixed metal oxide or dye may comprise at least one of Alumilite White (i.e., titanium (IV) oxide), Carbon Black (i.e., acetylene black), or 2,5-bis(5-tert-butyl-benzoxazol-2-yl)thiophene (BBOT).

In some embodiments, the resin may comprise a plasticizer. In some embodiments, the plasticizer may comprise dipropylene glycol dibenzoate. In some embodiments, the resin may not comprise a plasticizer.

In some embodiments, the resin may comprise at least one of any other suitable additive. In some embodiments, the additive may comprise at least one of AEROSIL® R 711, AEROSIL® R 972, AEROSIL® OX 50, triphenyl phosphate (Ph3PO4), or boric acid.

In some embodiments, the resin may be a thermoset. In some embodiments, the resin may be a thermoplastic.

In some embodiments, the resin may have a viscosity ranging from 1 cP to 100,000 cP. In some embodiments, the resin may have a viscosity ranging from 500 cP to 25,000 cP.

A resin may be 3D printed, and the resulting 3D-printed polymer may be foamed. In some embodiments, the resin may cause foaming in a 3D-printed polymer when triggered by a triggering event. In some embodiments, the resin may cause foaming in a 3D-printed polymer when triggered by heat. In some embodiments, the resin may cause foaming in a light-patterned, 3D-printed polymer when triggered by heat. In some embodiments, the resin may cause foaming in a Digital Light Processing-based (DLP-based), 3D-printed polymer when triggered by heat.

In some embodiments, a resin may be pot-stable and, when triggered by heat, cause foaming in a DLP-based, 3D-printed polymer. In some embodiments, the pot-stable resin may have its chemistry tuned between the resin and an additive shell and, when triggered by heat, cause foaming in a DLP-based, 3D-printed polymer. In some embodiments, such a pot-stable resin with tuned chemistry between the resin and the additive shell may be stable for longer than 6 months.

In some embodiments, a resin that causes foaming in a DLP-based, 3D-printed polymer when triggered by heat may undergo polymerization-induced phase separation (PIPS) during the printing process. In some embodiments, a resin that causes foaming in a DLP-based, 3D-printed polymer when triggered by heat and that undergoes PIPS during the printing process may cure to a gel state of 65% or 90% before undergoing a curing process. In some embodiments, the resin may be 3D printed using a DLP-based 3D printing process and undergo PIPS to produce a polymer that may then be cured at a curing temperature and foamed at a foaming onset temperature, wherein the curing temperature and the foaming onset temperature are tuned to within 20° C., within 10° C., within 5° C., or within 1° C. of each other.

### Photo-Polymerization and Foaming Methodology

In some embodiments, a resin may comprise expandable polymer microspheres. In some embodiments, expandable polymer microspheres may be used, for example, to increase the volume of a printed part formed from the resin. In some embodiments, a stable, 3D-printable resin results in a 3D-printed part with elastomeric properties that can subsequently be converted, by a thermal treatment, into a foam with a 50% to 60% lower density than the precursor material.

In some embodiments, methods of making and/or using a resin comprising expandable polymer microspheres may be provided. In some embodiments, a method to foam a printed, preformed polymer may be provided.

A method of preparing a photo-polymerized and foamed polymer material may comprise photo-polymerizing a resin including a thermally activated foaming agent to obtain a photo-polymerized polymer material. The method may further comprise heating the photo-polymerized polymer material at a heating temperature to obtain the photo-polymerized and foamed polymer material.

In some embodiments, photo-polymerization may comprise chain-transfer polymerization.

In some embodiments, photo-polymerizing the resin may comprise photo-printing parts from the resin. In some embodiments, photo-polymerizing the resin may comprise 3D printing parts from the resin. In some embodiments, 3D printing may comprise at least one of DLP 3D printing, SLA 3D printing, polymer jetting 3D printing, or binder jetting 3D printing. In some embodiments, predictive modeling may be used in the design of printed parts.

Photo-polymerizing a resin may cause the resulting photo-polymerized polymer material to separate into phases. In some embodiments, photo-polymerizing the resin may cause the photo-polymerized polymer material to undergo polymerization-induced phase separation. In some embodiments, the photo-polymerized polymer material may be microphase separated.

In some embodiments, a phase-separated photo-polymerized polymer material may comprise hard and soft phases. In some embodiments, the photo-polymerized polymer material may be tuned such that the hard phases soften just below the temperature at which the photo-polymerized polymer material's microspheres expand (i.e., at which the photo-polymerized polymer material forms a foam). In some embodiments, this may allow cooling of a printed part such that the part may retain a foamed state without collapsing.

In some embodiments, a photo-polymerization induced phase separation (photo-PIPS) process may be used. In some embodiments, a photo-PIPS process may capture the microspheres in a green state of the printed part (after photo-polymerization and phase separation, but before washing and curing).

The photo-polymerized polymer material may be cured. In some embodiments, the photo-polymerized polymer material may be cured with UV light. In some embodiments, a delayed network gelation of an initially cured polymer material may minimize stress concentrators due to the occurrence of thiol-click reactions. In some embodiments, a delayed network gelation of an initially cured polymer material may amplify the material's ability to sustain large, heterogenous shape changes during post-printing and foaming processes without damaging the structure of the underlying polymer network. In some embodiments, a photo-polymerized polymer material may be a fully cured, thermoset material with a volumetric expansion ratio ranging from 2 to 20.

In some embodiments, a relatively low-temperature washing, baking, and/or UV-curing process may be used to maximize the effectiveness and expansion capabilities of the photo-polymerized polymer material. In some embodiments, the toughness and resilience of the photo-polymerized polymer material may help the cured part to expand and foam without rupturing or reduce build-up of internal physical stresses.

In some embodiments, the photo-polymerized polymer material may be a 3D printed structure that is in its green state. In some embodiments, a photo-polymerized polymer material may have a gel content ranging from 20% to 100%. In some embodiments, the photo-polymerized polymer material may have a gel content of between 40% and 80%. In some embodiments, the photo-polymerized polymer material may have a gel content of greater than 90%. In some embodiments, the photo-polymerized polymer material may be fully cured. In some embodiments, a photo-polymerized polymer material may be foamed in a green state. In some embodiments, a photo-polymerized polymer material may be foamed in its fully cured state.

In some embodiments, the photo-polymerized polymer material may have a crosslinking density ranging from 1% to 20%.

In some embodiments, the photo-polymerized polymer material may have a degree of crystallinity ranging from 5% to 60%.

In some embodiments, the photo-polymerized and foamed polymer material may have a density ranging from 10% to 90% of the resin density.

In some embodiments, the photo-polymerized and foamed polymer material may have a macroscopic network geometry.

In some embodiments, the photo-polymerized polymer material may not be molded, gas-blown, vacuum-foamed, or infused with a foaming agent after being photo-polymerized.

The photo-polymerized polymer material may have a Young's modulus configured to permit foaming. In some embodiments, the photo-polymerized polymer material may have a Young's modulus configured to retain a foamed structure. In some embodiments, the photo-polymerized polymer material may have a Young's modulus of about 2 MPa.

In some embodiments, the photo-polymerized polymer material comprises expandable microspheres that are constrained by the Young's modulus of the surrounding phase. In some embodiments, the photo-polymerized polymer material may expand in a manner dictated by the rapid reduction in Young's modulus of the hard phase of the material in a multiphase system.

In some embodiments, microspheres in the photo-polymerized polymer material are not exposed to excessive temperatures following polymerization and curing.

Heating the photo-polymerized polymer material may comprise uniformly applying heat to a printed part. In some embodiments, heating may comprise convection heating. In some embodiments, heating may comprise induction heating. In some embodiments, particles of metal, such as silver, may be included in a resin so that the printed part formed from the resin may be heated by induction heating. In some embodiments, heating may comprise submersion heating using a liquid bath.

In some embodiments, the photo-polymerized polymer material is heated at about 450° F. to induce foaming.

A thermal gradient may be applied during heating. In some embodiments, a high thermal gradient is applied to a printed and cured part. In some embodiments, the printed and cured part has a lattice structure. In some embodiments, an even thermal gradient penetrates into a part. In some embodiments, the part has a porous and/or open lattice. In some embodiments, the part is configured so that stress concentration is minimized at locations that excessively constrain uniform expansion.

The thermally activated foaming agent may have a foaming onset temperature. In some embodiments, the foaming onset temperature may be about 115° C. In some embodiments, the heating temperature may be greater than or equal to the foaming onset temperature.

The photo-polymerized polymer material may have at least one thermal transition. The photo-polymerized polymer material may have at least one thermal transition temperature. In some embodiments, the thermal transition temperature may be within 100° C., within 50° C., or within 20° C. of the foaming onset temperature. In some embodiments, the at least one thermal transition temperature may peak at less than 170° C.

In some embodiments, the heating temperature may be greater than the at least one thermal transition temperature of the photo-polymerized polymer material. In some embodiments, the heating temperature may be within 100° C., within 50° C., within 20° C., or within 10° C. of the at least one thermal transition temperature. In some embodiments, the heating temperature may be about 170° C.

The photo-polymerized polymer material may have at least two thermal transitions. The photo-polymerized polymer material may have at least two thermal transition temperatures. In some embodiments, the heating temperature may be within 100° C. or 50° C. of the highest thermal transition temperature.

The at least one thermal transition of the photo-polymerized polymer material may be a glass transition. The at least one thermal transition temperature of the photo-polymerized polymer material may be a glass transition temperature (Tg). In some embodiments, the photo-polymerized polymer material may have a broad glass transition temperature range. In some embodiments, the at least one glass transition temperature may range from 50° C. to 200° C. In some embodiments, the photo-polymerized polymer material may have a glass transition temperature within 50° C. of the foaming onset temperature.

In some embodiments, the photo-polymerized polymer material has two or more glass transition temperatures. In some embodiments, by controlling where the highest glass transition temperature is relative to the foaming onset temperature, the recoverable force of the polymer network pushing back onto the microspheres may be tuned, which may be used to control the uniformity of foaming. In some embodiments, foaming may be controlled by varying the foaming onset temperature relative to a high Tg phase in a photo-PIPs printed material.

The glass transition temperature and/or plasticizer level of the photo-polymerized polymer material may be tuned. In some embodiments, tuning the glass transition temperature and/or plasticizer level may affect the Young's modulus of the polymer matrix of the photo-polymerized polymer material at the expansion temperature and control the extent to which the matrix may expand.

The at least one thermal transition of the photo-polymerized polymer material may be a melting transition. The at least one thermal transition temperature of the photo-polymerized polymer material may be a melting transition temperature. In some embodiments, the at least one melting transition temperature may range from 50° C. to 200° C.

In some embodiments, foaming in multi-phase thermosets may pre-condition the polymer network of the photo-polymerized polymer material. In some embodiments, softer (e.g., less sterically hindered) portions of the polymer network may resist foaming less, but with sufficient microsphere loads, the microspheres may rearrange and pre-strain the polymer network so as to amortize force distribution effectively.

In some embodiments, the local densities of segments of printed parts may be controlled by controlling the heating process. For example, some microspheres in certain segments of printed parts may not fully expand if they are insufficiently heated. As another example, sustained overheating of segments of printed parts may cause a predictable ratio of microspheres in those segments to overexpand and burst, in which case the recoverable force of the surrounding polymer network may cause the segment of the part to return to a partially foamed or pre-foamed state. In some embodiments, the heating process may be used to build closed-cell gradient densities within a single printed part.

In some embodiments, a printed part has a gradient in density due to a lattice structure, angles, and/or thicknesses of the printed geometry of the part.

In some embodiments, to minimize tearing during the foaming process, especially at high load levels of microspheres, segments of a printed lattice structure may be altered to minimize local forces. For example, linear beams of a printed lattice may be converted into structures of variable thicknesses with radii of curvature similar to ASTM dog bone shapes. As another example, linear beams of a printed lattice that were once rectangular prisms may be printed as cylinders of variable thicknesses, in which the thicknesses increase closer to nodes and/or points where the beams connect to the rest of the polymer network. In some embodiments, these shapes may minimize and more effectively distribute the internal forces on the polymer network that are applied by the foamed microspheres and may permit larger shape changes, improve tear resistance, and/or improve impact resistance in the foamed part.

A tool may be used to rapidly foam printed parts. The tool may generate neighboring walls of hot air that are pointed toward and move in different directions such that the net force applied to a printed part is zero. In some embodiments, a printed part may move on a conveyor belt through alternating flows of upward and downward walls of heated air to heat and foam the part. In some embodiments, the tool may generate two or more of such airflows. In some embodiments in which the tool generates multiple airflows, the temperature and flow velocity of the airflows may be modified to subject the part to specific thermal gradients in a continuous process.

In some embodiments, a stimulus-responsive resin may be 3D printable and expanded on demand, even in confined spaces or spaces that otherwise cannot be internally structured. In some embodiments, a photo-polymerized polymer material may be foamed while the photo-polymerized polymer material is externally constrained by a structure (e.g., a pipe).

In some embodiments, a photo-polymerized polymer material remains foamed after foaming.

Some embodiments may provide for control over and improvements in the properties and stability of printed and foamed parts. In some embodiments, a post-processing step may comprise at least one chosen from heating methods (e.g., convection and radiation), surface treatments (e.g., surface plasma treatment), chemical treatments (e.g., dip coating), and combinations thereof.

The photo-polymerized and foamed polymer material may increase in size during foaming as compared to the photo-polymerized polymer material before foaming. In some embodiments, foaming permits growth of a printed part to between 2 times and 4 times the size of its original printed dimensions. In some embodiments, a smallest sphere totally enclosing the photo-polymerized and foamed polymer material may be 2 to 20 times larger than a smallest sphere totally enclosing the photo-polymerized polymer material before foaming.

In some embodiments, foaming a printed part may scale the size of the printed part without changing the geometry of the underlying structure of the printed part.

In some embodiments, only a portion of the photo-polymerized polymer material may be foamed.

In some embodiments, a two-stage processing cycle may be used, wherein the event triggering foaming (e.g., heating) of a part can be physically separated from the printing and curing of the resin used to form the part. In some embodiments, a photo-polymerization step may be fully decoupled from a heating step. In some embodiments, decoupling of the photo-polymerization and heating steps may be achieved by controlling the amount of expansion of the photo-polymerized polymer material based on at least one of a mechanical property of the photo-polymerized polymer material, the amount of foaming agent in the photo-polymerized polymer material, a heating temperature, or a time of heat exposure. In some embodiments, the separation of processing stages may afford significant benefits to supply chains for finished goods, as end products may take up less space, and therefore be capable of being more densely packed, and/or avoid damage or deformation during shipment.

Printing throughput may be increased by any of the disclosed processes. In some embodiments, printed structures may be up to about 8 times denser than their final, foamed forms and can be expanded into any number of desired final shapes. In some embodiments, printing denser structures that can later be foamed into their final shapes may increase printing throughput considerably and help amortize the cost of a printer or further printing. For example, in some embodiments, the disclosed processes may support the printing of more than 100 shoe midsoles on a build area of an ETEC® Xtreme 8K printer in the same amount of time that it would have taken to print 13 midsoles on the same build area using other processes. In some embodiments, the disclosed processes may support the printing of more than 50 midsoles at twice the speed at which 13 midsoles could be printed on the same build area of an Xtreme 8K printer using other processes.

### Photo-Polymerized and Foamed Polymer Materials and Structures

In some embodiments, a photo-polymerized and foamed polymer material made according to any of the methods described herein may be provided.

In some embodiments, a photo-polymerized and foamed polymer material may be a thermoset. In some embodiments, a photo-polymerized and foamed polymer material may be a thermoplastic.

In some embodiments, the photo-polymerized and foamed polymer material may have a density ranging from 0.1 g/cm³ to 1.5 g/cm³ at standard temperature and pressure. In some embodiments, the photo-polymerized and foamed polymer material may have a density less than 0.9 g/cm³ at standard temperature and pressure. In some embodiments, the photo-polymerized and foamed polymer material may have a density ranging from 0.33 g/cm³ to 0.9 g/cm³ at standard temperature and pressure. In some embodiments, the photo-polymerized and foamed polymer material may have a density less than 0.33 g/cm³ at standard temperature and pressure.

In some embodiments, the photo-polymerized and foamed polymer material may have a volume density of about 1.5%.

In some embodiments, the photo-polymerized and foamed polymer material may have a toughness ranging from 1 MJ/m³ to 100 MJ/m³ at standard temperature and pressure.

In some embodiments, the photo-polymerized and foamed polymer material may have an elongation at break ranging from 5% to 1000% at standard temperature and pressure. In some embodiments, the photo-polymerized and foamed polymer material may have an elongation at break greater than 100%, greater than 200%, or greater than 400% at standard temperature and pressure.

In some embodiments, the photo-polymerized and foamed polymer material may have a Young's modulus ranging from 0.1 MPa to 300 MPa at standard temperature and pressure.

In some embodiments, the photo-polymerized and foamed polymer material may have a degree of crystallinity ranging from 5% to 60% at standard temperature and pressure.

In some embodiments, the photo-polymerized and foamed polymer material may have a low chemical crosslinking density. In some embodiments, the photo-polymerized and foamed polymer material may have a chemical crosslinking density ranging from 1% to 20% at standard temperature and pressure.

In some embodiments, the photo-polymerized and foamed polymer material may have two or more glass transition temperatures.

The photo-polymerized and foamed polymer material may have a macroscopic network geometry. In some embodiments, the macroscopic network geometry may have a lattice structure. In some embodiments, the lattice structure may comprise an irregular lattice structure. In some embodiments, the photo-polymerized and foamed polymer material may have a less than 0.6 g/cc dense open-lattice structure. In some embodiments, the photo-polymerized and foamed polymer material may have a less than 0.6 g/cc dense closed-cell lattice structure. In some embodiments, the macroscopic network geometry may comprise a plurality of foamed polymer links, with each foamed polymer link having a longest dimension ranging from 0.01 mm to 10 mm and being joined to two or more foamed polymer links.

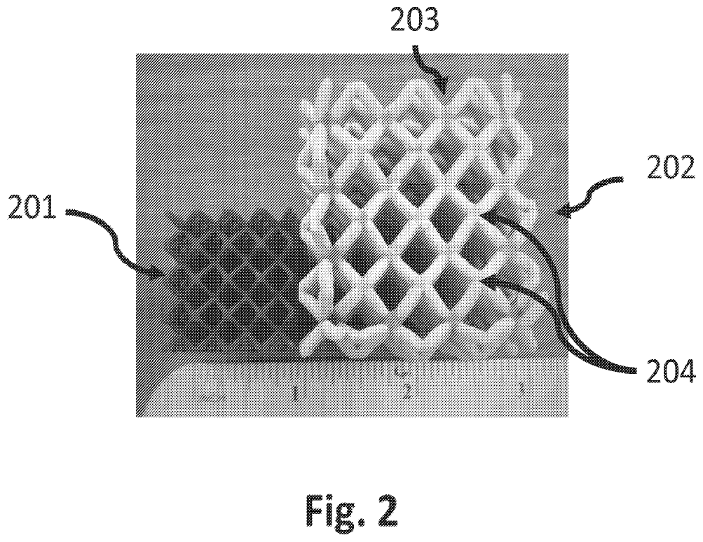

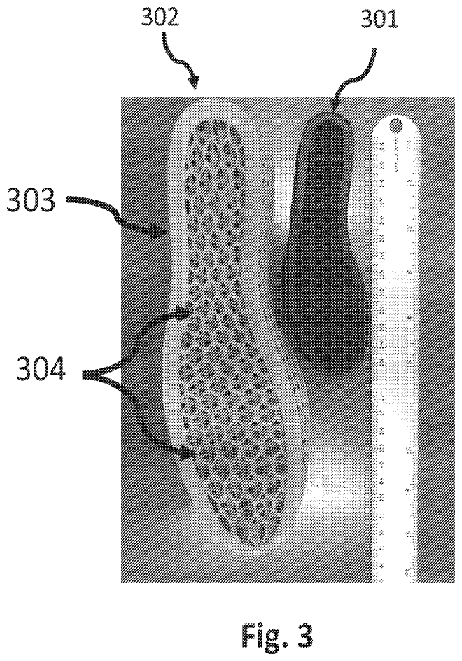

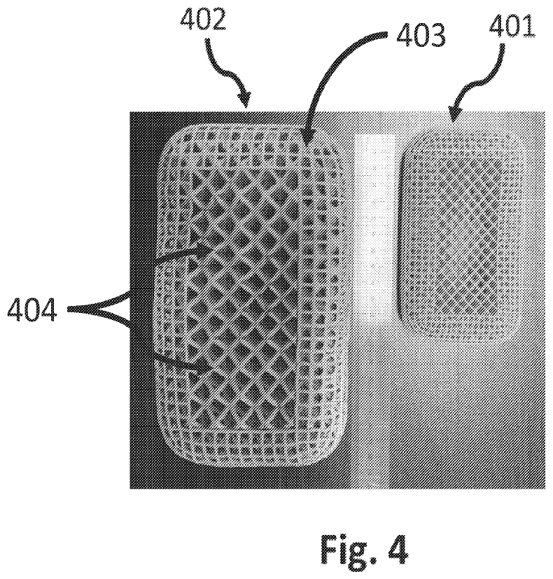

By way of example, FIG. 2, FIG. 3, and FIG. 4 each depict exemplary photo-polymerized polymer materials before (201, 301, 401) and after (202, 302, 402) foaming. Photo-polymerized polymer materials 202, 302, and 402 each have a macroscopic network geometry (203, 303, 403) comprising a plurality of foamed polymer links (204, 304, 404).

In some embodiments, the photo-polymerized and foamed polymer material has a closed-cell foam in an open lattice architecture. In some embodiments, a DLP-based photo-polymerized and foamed polymer material has a closed-cell foam in an open lattice architecture.

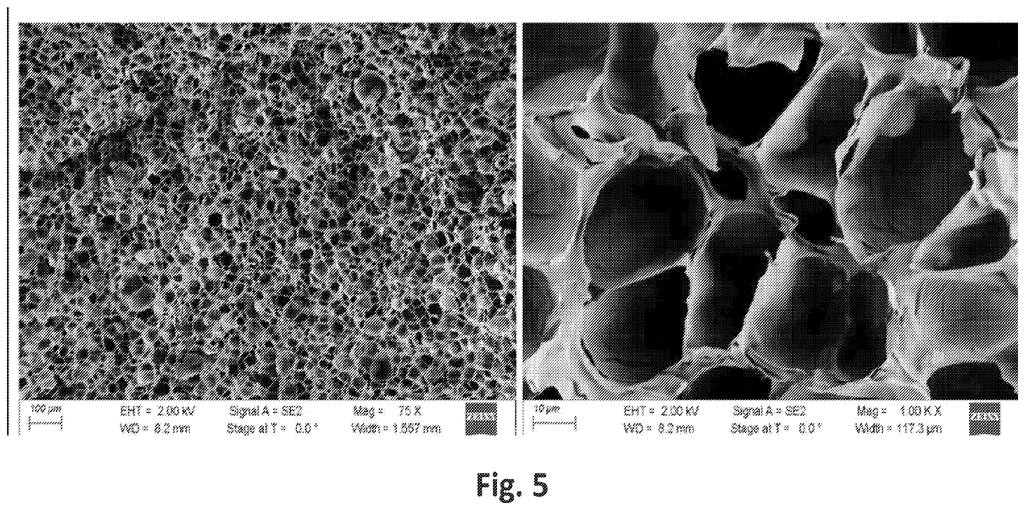

FIG. 5 depicts an image of an exemplary photo-polymerized and foamed polymer material after cold fracture that has been rendered using scanning electron microscopy (SEM). The exemplary photo-polymerized and foamed polymer material exhibits a closed-cell foam in an open lattice architecture.

In some embodiments, the photo-polymerized and foamed polymer material may be substantially homogeneous. In some embodiments, the photo-polymerized and foamed polymer material may have a polymerization-induced phase-separated structure. In some embodiments, the photo-polymerized and foamed polymer material may have a photo-polymerization-induced phase-separated structure. In some embodiments, the photo-polymerized and foamed polymer material may have a memory-foam nature.

In some embodiments, a photo-polymerized and foamed polymer material made according to any of the methods described herein may be used to produce a footwear component or a bedding component. In some embodiments, the footwear component may be a shoe midsole or a combination shoe midsole and outsole. In some embodiments, the bedding component may be a pillow or a mattress. In some embodiments, the mattress may be an infant-sized mattress; a toddler-sized mattress; a cot-sized mattress; a small, Single-sized mattress; a Twin-sized mattress; a Twin XL-sized mattress; a Full-sized mattress, a Double-sized mattress; a Queen-sized mattress; a King-sized mattress; or a California King-sized mattress.

In some embodiments, a photo-polymerized and foamed polymer material made according to any of the methods described herein may be used to produce upholstered furniture, cushioning, a noise dampening device, a vibration control device, a sealant, thermal insulation, an impact-resistant device, or a flotation device.

In some embodiments, a 3D-printed, foamed polymeric structure may be provided.

In some embodiments, the polymeric structure may comprise from 80 weight % to 100 weight % polymer by total weight of the polymeric structure.

In some embodiments, the polymeric structure may have a toughness ranging from 1 MJ/m³ to 100 MJ/m³ at standard temperature and pressure.

In some embodiments, the polymeric structure may have an elongation at break ranging from 5% to 1000% at standard temperature and pressure.

In some embodiments, the polymeric structure may have a Young's modulus ranging from 0.1 MPa to 300 MPa at standard temperature and pressure.

In some embodiments, the polymeric structure may have a degree of crystallinity ranging from 5% to 60% at standard temperature and pressure.

In some embodiments, the polymeric structure may have a chemical crosslinking density ranging from 1% to 20% at standard temperature and pressure.

The polymeric structure may have a macroscopic network geometry. In some embodiments, the macroscopic network geometry may have a lattice structure. In some embodiments, the lattice structure may comprise an irregular lattice structure. In some embodiments, the polymeric structure may have a less than 0.6 g/cc dense open-lattice structure. In some embodiments, the polymeric structure may have a less than 0.6 g/cc dense closed-cell lattice structure. In some embodiments, the macroscopic network geometry may comprise a plurality of foamed polymer links, with each foamed polymer link having a longest dimension ranging from 0.01 mm to 10 mm and being joined to two or more foamed polymer links.

In some embodiments, the polymeric structure may have a density determined by the as-printed lattice (e.g., open lattice) made up of struts with a closed-cell foam structure.

In some embodiments, the polymeric structure may comprise a microphase-separated morphology. In some embodiments, the polymeric structure may consist essentially of a microphase-separated morphology.

In some embodiments, a polymeric structure of a photo-polymerized and foamed polymer material made according to any of the methods described herein may be used to produce a footwear component or a bedding component. In some embodiments, the footwear component may be a shoe midsole or a combination shoe midsole and outsole. In some embodiments, the bedding component may be a pillow or a mattress. In some embodiments, the mattress may be an infant-sized mattress; a toddler-sized mattress; a cot-sized mattress; a small, Single-sized mattress; a Twin-sized mattress; a Twin XL-sized mattress; a Full-sized mattress, a Double-sized mattress; a Queen-sized mattress; a King-sized mattress; or a California King-sized mattress.

In some embodiments, a polymeric structure of a photo-polymerized and foamed polymer material made according to any of the methods described herein may be used to produce upholstered furniture, cushioning, a noise dampening device, a vibration control device, a sealant, thermal insulation, an impact-resistant device, or a flotation device.

### Experimental Techniques

The resins, photo-polymerized polymer materials, and photo-polymerized and foamed polymer materials may be characterized using the following techniques.

### Liquid and Solid Density:

Liquid density was measured using a 25 ml volumetric flask and an appropriate analytical laboratory scale. Liquid samples were prepared in accordance with ASTM D1475. The empty volumetric flask was tared on the scale before adding the liquid sample carefully up to the denoted line, avoiding any air bubbles. The filled volumetric flask was then weighed, and the liquid density was calculated by dividing the final liquid weight by the volume of the liquid. The liquid density (g/ml or g/cm³) was then reported, along with the temperature of the liquid sample at the time of testing.

Solid density was measured using a caliper and an appropriate analytical laboratory scale. The solid bulk uniform sample was measured and weighed. The solid density (g/cm³) was calculated by dividing the sample weight by the volume of the sample.

### Gel Content:

Gel content was tested using a modified version of ASTM D2765-16, wherein toluene was replaced with hexane (technical grade) as a washing solvent, and wherein a closed, rotating glass jar with at least 100 parts of solvent per part of polymer was used for 24 hours, at room temperature, to remove extractable material in lieu of a Soxhlet extractor.

### Tensile Testing:

Uniaxial tensile testing was performed on an Instron 34TM-5 Universal Testing Machine with an SVE-2 video extensometer. Test specimens of materials were prepared with dimensions in accordance with ASTM standard D638 Type V. Each test specimen was placed in the grips of the testing machine. The distance between the ends of the gripping surfaces was recorded. After setting the speed of testing at the proper rate, the machine was started. The load-extension cure of the specimen was recorded. The load and extension at the moment of rupture was recorded. Testing and measurements were performed in accordance with ASTM D638 guidelines.

### Toughness:

Toughness was measured using an ASTM D638 standard tensile test as described above. The dimensions of the Type V dogbone specimen were as follows:

$$Width of narrow section ( W ) = 3.18 \pm 0.5 mm \qquad [ 138 ]$$

$$Length of narrow section ( L ) = 9.53 \pm 0.5 mm \qquad [ 139 ]$$

$$Gage length ( G ) = 7.62 \pm 0.25 mm \qquad [ 140 ]$$

$$Radius of fillet ( R ) = 12.7 \pm 1. mm \qquad [ 141 ]$$

Tensile testing was performed using a testing speed of 100 mm/min. For each test, the energy required to break was determined from the area under the load trace up to the point at which rupture occurred (denoted by a sudden load drop). This energy was then calculated to obtain the toughness (MJ/m³).

### Strain at Break:

Strain at break was measured using an ASTM D638 standard tensile fest as described above. The dimensions of the Type V dogbone specimen were as follows:

$$Width of narrow section ( W ) = 3.18 \pm 0.5 mm \qquad [ 145 ]$$

$$Length of narrow section ( L ) = 9.53 \pm 0.5 mm \qquad [ 146 ]$$

$$Gage length ( G ) = 7.62 \pm 0.25 mm \qquad [ 147 ]$$

$$Radius of fillet ( R ) = 12.7 \pm 1. mm \qquad [ 148 ]$$

Tensile testing was performed using a speed of testing of 100/mm/min. For each test, the gauge length extension at the point of rupture was divided by the original gauge length (i.e., the distance between the ends of the gripping surfaces) and multiplied by 100.

### Dynamic Mechanical Analysis (DMA):

Dynamic mechanical analysis (DMA) measurements were performed on a Perkin Elmer DMA 8000 Analyzer with Hi Temp Furnace SST. A test specimen of material 12 mm long. 7 mm wide, and 0.025-3.0 mm thick was used. The specimen was subjected to a tensile force at 1 Hz with an average amplitude of 2 N and a maximum displacement of 20 μm. Glass transition temperature (Tg) was measured as the peak of tan delta (i.e., the ratio of the loss and storage moduli). DMA testing was performed in accordance with ASTM D4065 guidelines.

### Hardness:

Hardness was obtained using a Shore A Durometer (1-100 HA±0.5 HA). Hardness testing was performed in accordance with ASTM D2240 guidelines.

### Viscosity:

Viscosity (mPa-s) was obtained using a Brookfield LV-1 viscometer. The temperature of the liquid sample (in ° C.) was also recorded at the time of testing. Viscosity testing was performed in accordance with ASTM D2196 guidelines.

### EXAMPLES

The present invention will now be further illustrated by reference to the accompanying examples.

### Preparation of Resins:

Exemplary resins with the following components were prepared in accordance with the procedures outlined below:
about 3-10 pph of a first monomer;
100 pph of a second monomer;
about 0.9-2.1 pph of a photo-activated polymerization catalyst; and
about 5-30 pph of a thermally activated foaming agent.

As used herein, the “pph” of a compound in a resin, wherein the resin has at least one methacrylate, acrylate, or acrylamide, is parts by mass of the compound per hundred parts of total mass of methacrylate, acrylate, and acrylamide compounds in the resin.

In certain exemplary resins, the first monomer comprised at least one of EDDT, BD1, PE1, or NR1.

In certain exemplary resins, the second monomer comprised at least one of isobornyl methacrylate, tert-butyl methacrylate, 2-ethylhexyl methacrylate, isodecyl methacrylate, 2-hydroxyethyl methacrylate, lauryl methacrylate, trimethylolpropane trimethacrylate, isobornyl acrylate, 2-ethylhexyl acrylate, cyclic trimethylolpropane formal acrylate, hydroxypropyl acrylate, poly(propylene glycol) diacrylate, tricyclodecanedimethanol diacrylate, trimethylolpropane triacrylate, tri (propylene glycol) diacrylate, poly(ethylene glycol) diacrylate, Silmer® OH ACR Di-400, CN1966, CN9002, CN9004, CN9028, CN9070, CN9782, or N, N′-methylenebis(acrylamide).

In certain exemplary resins, the photo-activated polymerization catalyst comprised at least one of TPO or BAPO.

In certain exemplary resins, the thermally activated foaming agent comprised at least one of Sekisui ADVANCELL EML 101 or Sekisui ADVANCELL EM 504.

In certain exemplary resins, at least one of an inhibitor, a dye, or an additive was added. In certain exemplary resins, an inhibitor comprising at least one of BHT, pentaerythritol tetrakis(3,5-di-tert-butyl-4-hydroxyhydrocinnamate), HQ, MHQ, 1,3-diallyl-2-thiourea, or 2,2′-diallyl bisphenol A was added. In certain exemplary resins, a dye comprising at least one of Alumilite White, Carbon Black (i.e., acetylene black), or BBOT was added. In certain exemplary resins, an additive comprising at least one of dipropylene glycol dibenzoate, AEROSIL® R 711, AEROSIL® R 972, AEROSIL® OX 50, triphenyl phosphate, or boric acid was added.

To prepare each resin, all low-viscosity liquid resin components (e.g., monomers and certain additives) were initially added to a mixing vessel. For small-batch samples, mixing vessels like vials or other small containers were used; large mixing vessels and high shear dispersion blades were used to mix larger samples. Next, all solid resin components (e.g., photo-activated polymerization catalysts, inhibitors, and certain additives) were added to the mixing vessel. These resin components were mixed until proper dissolution or distribution of the solid components into the liquid components was achieved. All high-viscosity liquid resin components (e.g., oligomers, dyes, and certain additives) were then added to the mixing vessel, and the components therein were mixed again as described above. After adequate mixing, the resin was ready for casting or for use in 3D printing.

Additionally, control resins with the following components were prepared in accordance with the above procedures:
about 3-10 pph of a first monomer;
100 pph of a second monomer; and
about 0.9-2.1 pph of a photo-activated polymerization catalyst.

The materials prepared from these control resins were used as comparison points in examining the influence of the thermally activated foaming agent on certain properties (e.g., Tg, tan delta, Young's modulus) of the photo-polymerized polymer materials prepared from the exemplary resins.

### Preparation of Samples for Testing:

To prepare a solid sheet test sample from a completed resin, two 6″×6″ glass sheets were coated with a non-stick coating to make it easier to remove the polymerized sheet. Microscope slides 1 mm thick were used as spacers and to create a mold to contain the liquid resin. The resin was then poured into the mold and clamped down with clips. The mold was placed into a UV-cure oven emitting light at a wavelength that would induce the photo-activated polymerization catalyst to initiate polymerization of the resin. Upon polymerization, the polymerized sheet was removed from the mold, and ASTM dye cutters were used to excise appropriate testing samples.

To prepare a 3D-printed test sample from a completed resin, the completed liquid resin was placed into a vat or container of a 3D printer. Using the 3D printer, the test sample was 3D printed to ASTM specifications directly in the x, y, or z orientation depending on the axis required for testing. (Foamed samples were printed on scale to compensate for the foaming process.) After printing, the sample was removed from the 3D printer and washed with a solvent to remove excess unpolymerized resin. Once thoroughly cleaned, the sample was placed into a thermal oven to evaporate excess wash solvent. After drying, the sample was placed into a UV-cure oven to finish polymerizing. Once fully polymerized, the sample was ready for testing.

For foamed samples, the test samples were treated with heat to foam the microspheres in the test samples prior to testing.

### Example 1: V₀ Resins

Exemplary resins comprising the following components were prepared:
about 3-8 pph of a first monomer;
100 pph of a second monomer;
about 1-1.5 pph of a photo-activated polymerization catalyst; and
about 5-30 pph of a thermally activated foaming agent.

In certain exemplary resins, the first monomer comprised at least one of BD1 or PE1.

In certain exemplary resins, the second monomer comprised at least one of CN9070, isobornyl methacrylate, or isobornyl acrylate.

In certain exemplary resins, the photo-activated polymerization catalyst comprised TPO.

In certain exemplary resins, the thermally activated foaming agent comprised Sekisui ADVANCELL EML 101.

In certain exemplary resins, at least one of an inhibitor, a dye, or an additive was added. In certain exemplary resins, an inhibitor comprising BHT was added. In certain exemplary resins, a dye comprising at least one of Alumilite White or BBOT was added.

The following table sets forth the possible proportions of components that could have been mixed into an exemplary resin:

TABLE 1
EXAMPLE 1 RESINS

| Component | Concentration (pph) |
|---|---|
| BD1 | 0-3 |
| PE1 | 2-7 |
| CN9070 | 60-70 |
| IBOMA | 30-40 |
| IBOA | 0-5 |
| TPO | 1-1.5 |
| EML 101 | 5-30 |
| BHT | 0-0.2 |
| BBOT | 0-0.01 |
| Alumilite White | 0-0.4 |

BD1: 1,4-Bis(3-mercaptobutyryloxy) butane
PE1: Pentaerythritol tetrakis(3-mercaptobutylate)
CN9070: Sartomer®, aliphatic urethane acrylate oligomer
IBOMA: Isobornyl methacrylate
IBOA: Isobornyl acrylate
TPO: Diphenyl(2,4,6-trimethylbenzoyl) phosphine oxide
EML 101: Sekisui ADVANCELL EML 101
BHT: Butylated hydroxytoluene
BBOT: 2,5-Bis(5-tert-butyl-benzoxazol-2-yl)thiophene

The photo-polymerized and foamed polymer materials formed from these exemplary resins had an elongation at break ranging from about 25% to about 300% and a Shore A hardness ranging from about 35 to about 75 at standard temperature and pressure.

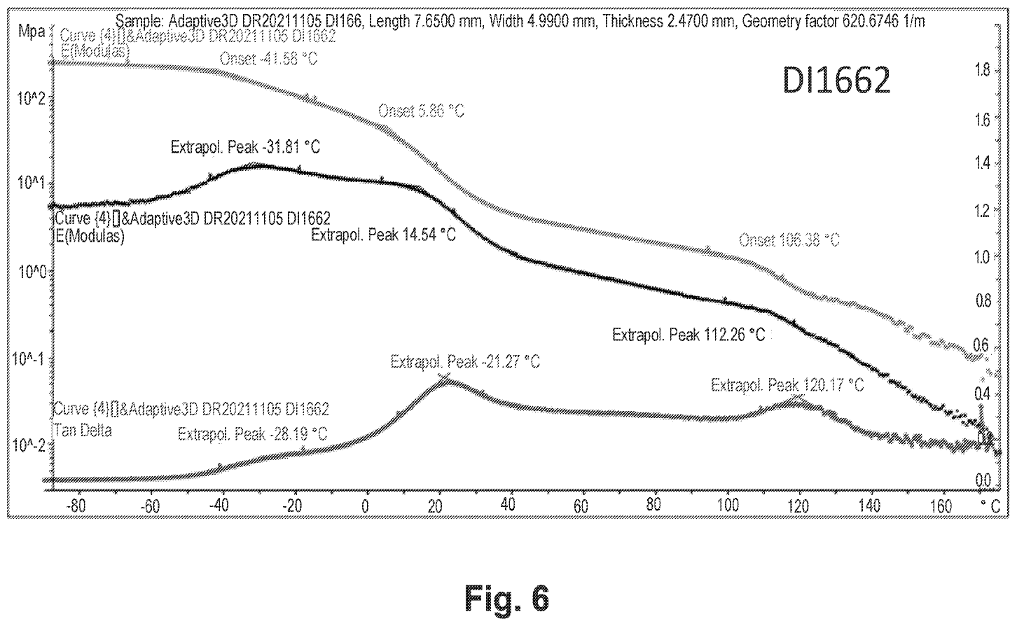

FIG. 6 presents the results of DMA analysis performed on a photo-polymerized polymer material prepared using an exemplary resin within this group.

### Example 2: V₁/V₂ Resins

Exemplary resins comprising the following components were prepared:
about 5-10 pph of a first monomer;
100 pph of a second monomer;
about 1-1.5 pph of a photo-activated polymerization catalyst;
about 10-25 pph of a thermally activated foaming agent; and
about 0.1-0.4 pph of an inhibitor.

In certain exemplary resins, the first monomer comprised PE1.

In certain exemplary resins, the second monomer comprised at least one of CN9004, 2-hydroxyethyl methacrylate, isobornyl methacrylate, or trimethylolpropane triacrylate.

In certain exemplary resins, the photo-activated polymerization catalyst comprised TPO.

In certain exemplary resins, the thermally activated foaming agent comprised at least one of Sekisui ADVANCELL EML 101 or Sekisui ADVANCELL EM 504.

In certain exemplary resins, the inhibitor comprised at least one of BHT or pentaerythritol tetrakis(3,5-di-tert-butyl-4-hydroxyhydrocinnamate).

In certain exemplary resins, at least one of a dye or an additive was added. In certain exemplary resins, a dye comprising at least one of Alumilite White or Carbon Black was added. In certain exemplary resins, an additive comprising at least one of dipropylene glycol dibenzoate, triphenyl phosphate, or boric acid was added.

The following table sets forth the possible proportions of components that could have been mixed into an exemplary resin:

TABLE 2
EXAMPLE 2 RESINS

| Component | Concentration (pph) |
|---|---|
| PE1 | 5-10 |
| CN9004 | 49.9-60 |
| 2-HEMA | 25-40 |
| IBOMA | 0-20 |
| TMPTA | 0-0.1 |
| TPO | 1-1.5 |
| EML 101 | 0-25 |
| EM 504 | 0-20 |
| BHT | 0-0.3 |
| IRGANOX 1010 | 0-0.4 |
| Alumilite White | 0-0.4 |
| Carbon Black | 0-0.03 |
| Boric Acid | 0-1 |
| Dipropylene Glycol Dibenzoate | 0-30 |
| Ph3PO4 | 0-30 |

PE1: Pentaerythritol tetrakis(3-mercaptobutylate)
CN9004: Sartomer ®, aliphatic urethane acrylate oligomer
2-HEMA: 2-Hydroxyethyl methacrylate
IBOMA: Isobornyl methacrylate
TMPTA: Trimethylolpropane triacrylate
TPO: Diphenyl(2,4,6-trimethylbenzoyl)phosphine oxide
EML 101: Sekisui ADVANCELL EML 101
EM 504: Sekisui ADVANCELL EM 504
BHT: Butylated hydroxytoluene
Ph3PO4: Triphenyl phosphate

The photo-polymerized and foamed polymer materials formed from certain exemplary resins had an elongation at break ranging from about 40% to about 175% and a Shore A hardness ranging from about 40 to about 100 at standard temperature and pressure.

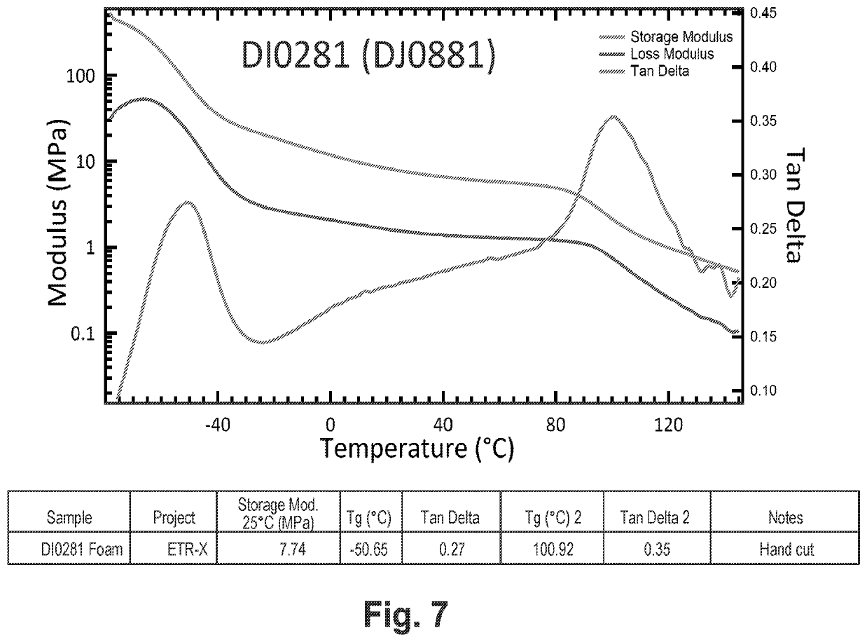

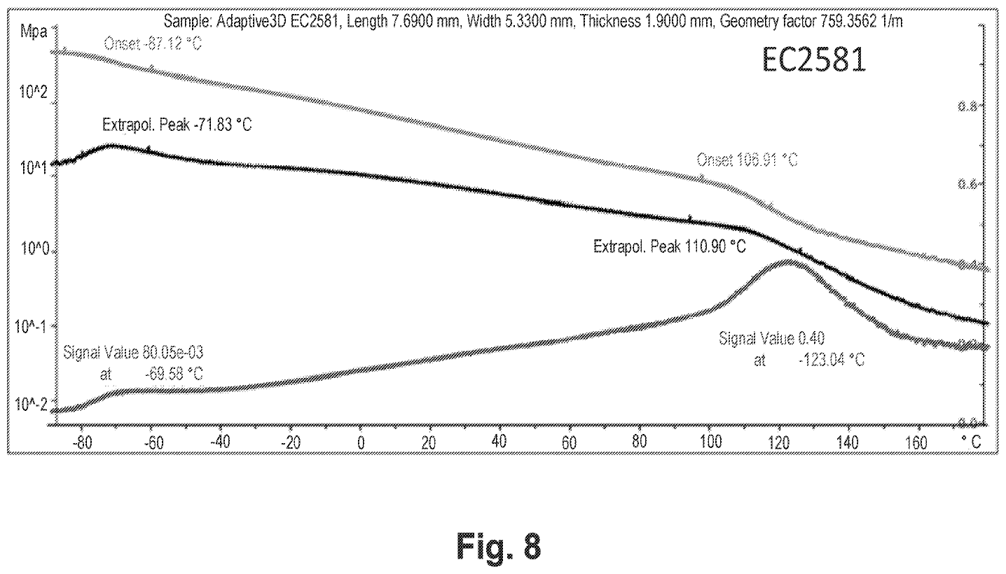

FIG. 7 and FIG. 8 each present the results of DMA analysis performed on a photo-polymerized polymer material prepared using an exemplary resin within this group.

### Example 3: V₃ Resins

Exemplary resins comprising the following components were prepared:
about 4.3-8.5 pph of a first monomer;
100 pph of a second monomer;
about 0.9-2.1 pph of a photo-activated polymerization catalyst;
about 17.4-25 pph of a thermally activated foaming agent; and
about 0.1-0.5 pph of an inhibitor.

In certain exemplary resins, the first monomer comprised PE1.

In certain exemplary resins, the second monomer comprised at least one of CN9004, isobornyl methacrylate, tert-butyl methacrylate, poly(propylene glycol) diacrylate, 2-ethylhexyl methacrylate, tri (propylene glycol) diacrylate, trimethylolpropane triacrylate, 2-hydroxyethyl methacrylate, tricyclodecanedimethanol diacrylate, isodecyl methacrylate, poly(ethylene glycol) diacrylate, or lauryl methacrylate.

In certain exemplary resins, the photo-activated polymerization catalyst comprised TPO.

In certain exemplary resins, the thermally activated foaming agent comprised at least one of Sekisui ADVANCELL EML 101 or Sekisui ADVANCELL EM 504.

In certain exemplary resins, the inhibitor comprised at least one of BHT or pentaerythritol tetrakis(3,5-di-tert-butyl-4-hydroxyhydrocinnamate).

In certain exemplary resins, at least one of a dye or an additive was added. In certain exemplary resins, a dye comprising Alumilite White was added. In certain exemplary resins, an additive comprising at least one of dipropylene glycol dibenzoate, AEROSIL® R 711, or triphenyl phosphate was added.

The following table sets forth the possible proportions of components that could have been mixed into an exemplary resin:

TABLE 3
EXAMPLE 3 RESINS

| Component | Concentration (pph) |
|---|---|
| PE1 | 4.3-8.5 |
| CN9004 | 60-70 |
| IBOMA | 12-35 |
| TBMA | 0-20 |
| PPGDA | 0-5 |
| EHMA | 0-7.5 |
| TPGDA | 0-2.6 |
| TMPTA | 0-0.1 |
| 2-HEMA | 0-12 |
| TCDA | 0-2.7 |
| IDMA | 0-5 |
| PEGDA | 0-2.2 |
| Lauryl methacrylate | 0-5 |
| TPO | 0.9-2.1 |
| EML 101 | 0-25 |
| EM 504 | 0-20 |
| BHT | 0-0.1 |
| IRGANOX 1010 | 0-0.5 |
| Alumilite White | 0-0.5 |
| Dipropylene Glycol Dibenzoate | 0-20 |
| Ph3PO4 | 0-0.3 |
| AEROSIL 711 | 0-4.1 |

PE1: Pentaerythritol tetrakis(3-mercaptobutylate)
CN9004: Sartomer ®, aliphatic urethane acrylate oligomer
IBOMA: Isobornyl methacrylate
TBMA: Tert-butyl methacrylate
PPGDA: Poly(propylene glycol) diacrylate
EHMA: 2-Ethylhexyl methacrylate
TPGDA: Tri(propylene glycol) diacrylate
TMPTA: Trimethylolpropane triacrylate
2-HEMA: 2-Hydroxyethyl methacrylate
TCDA: Tricyclodecanedimethanol diacrylate (tricyclo[5.2.1.02,6]decanedimethanol diacrylate)
IDMA: Isodecyl methacrylate
PEGDA: Poly(ethylene glycol) diacrylate
TPO: Diphenyl(2,4,6-trimethylbenzoyl)phosphine oxide
EML 101: Sekisui ADVANCELL EML 101
EM 504: Sekisui ADVANCELL EM 504
BHT: Butylated hydroxytoluene
Ph3PO4: Triphenyl phosphate

Additionally, control resins excluding thermally activated foaming agents (e.g., TPO) were prepared using the above components. The materials prepared from these control resins were used as comparison points in examining the influence of the thermally activated foaming agent on certain properties (e.g., Tg, tan delta, Young's modulus) of the photo-polymerized polymer materials prepared from this group of exemplary resins.

The photo-polymerized and foamed polymer materials formed from certain exemplary resins had an elongation at break ranging from about 100% to about 450%, a Shore A hardness ranging from about 40 to about 100, a tensile strength ranging from 2 MPa to about 12 MPa, and a toughness ranging from about 1 MJ/m³ to about 30 MJ/m³ at standard temperature and pressure. Certain of these photo-polymerized and foamed polymer materials had an elongation at break ranging from about 275% to about 325%, a Shore A hardness ranging from about 50 to about 55, a tensile strength ranging from about 3 MPa to about 6 MPa, and a toughness ranging from about 5 MJ/m³ to about 10 MJ/m³ at standard temperature and pressure.

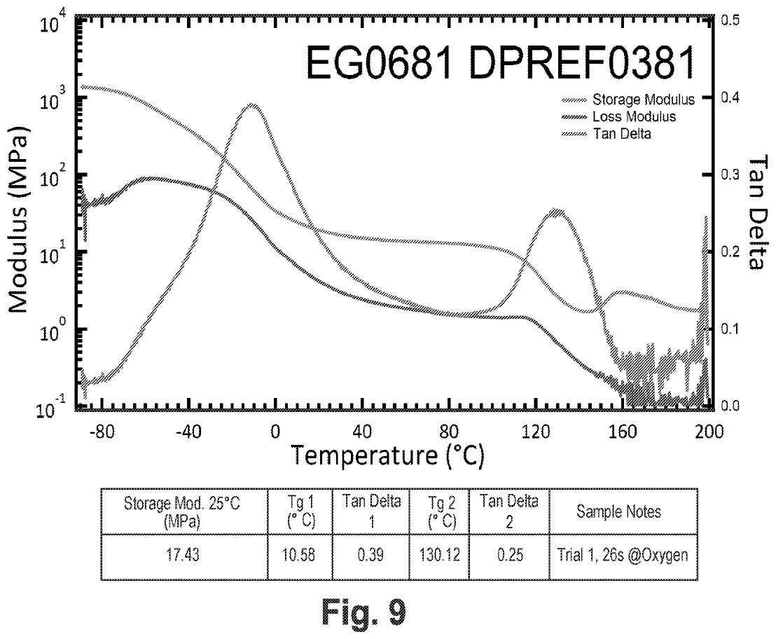

Some of the materials formed from certain exemplary resins exhibited unique and unexpected properties, as shown, for example, in FIG. 9, which presents results of DMA analysis performed on a photo-polymerized polymer material prepared using an exemplary resin within this group. A photo-polymerized polymer material within this group could have exhibited a glass transition at a glass transition temperature of between 70° C. and 80° C., yet in fact often exhibited at least one glass transition at a first glass transition temperature ranging from about −40° C. to about 40° C. In addition, such a material may have further exhibited a second glass transition temperature ranging from about 120° C. to about 160° C.

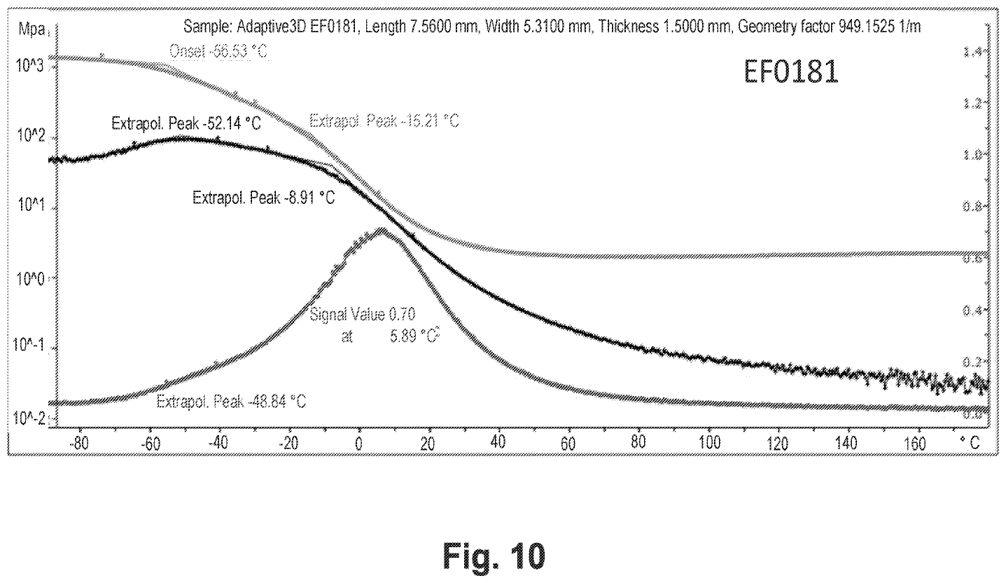

Despite the above, a core photo-polymerized polymer material (i.e., a photo-polymerized polymer material lacking a foaming agent) within this group was a highly stiff material, with a Young's modulus ranging from 4 MPa to 8 MPa over the temperature range of 40° C. to 200° C., and a tan delta ranging from 0.01 to 0.2 over the temperature range of 40° C. to 200° C. FIG. 10 presents the results of DMA analysis performed on a photo-polymerized polymer material formed from a sample control resin exhibiting these properties. In addition, a photo-polymerized polymer material (with the foaming agent) within this group exhibited a storage modulus ranging from 1 MPa to 10 MPa over the temperature range of the material's first glass transition temperature to 20° C., 60° C., or 160° C. above said first glass transition temperature, and a tan delta ranging from 0.02 to 0.2 over the temperature range of the material's first glass transition temperature to 20° C., 60° C., or 160° C. above said first glass transition temperature. And a photo-polymerized and foamed polymer material within this group exhibited a Young's modulus ranging from 8 MPa to 12 MPa over the temperature range of 40° C. to 100° C., and a tan delta ranging from 0.02 to 0.2 over the temperature range of 40° C. to 100° C. The decreased stability of the photo-polymerized and foamed polymer material relative to that of the photo-polymerized polymer materials is attributed to the influence of the polymer shell surrounding the at least one microsphere in the foaming agent, which has a glass transition temperature of about 120° C.

Without wishing to be bound by theory, it is believed that these unique and unexpected properties may be caused, at least in part, either by phase separation of the photo-polymerized polymer materials caused by the 3D printing process, or by random or segmented copolymerization of the lower-content monomers, which may lead the main components of the resins to significantly influence the glass transition temperatures of the resulting polymer materials.

Claims or descriptions that include “or” or “and/or” between at least one members of a group are considered satisfied if one, more than one, or all of the group members are present in, employed in, or otherwise relevant to a given product or process unless indicated to the contrary or otherwise evident from the context. The disclosure includes embodiments in which exactly one member of the group is present in, employed in, or otherwise relevant to a given product or process. The disclosure includes embodiments in which more than one or all the group members are present in, employed in, or otherwise relevant to a given product or process.

Furthermore, the disclosure encompasses all variations, combinations, and permutations in which at least one limitation, element, clause, and descriptive term from at least one of the listed claims is introduced into another claim. For example, any claim that is dependent on another claim can be modified to include at least one limitation found in any other claim that is dependent on the same base claim. Where elements are presented as lists, such as, e.g., in Markush group format, each subgroup of the elements is also disclosed, and any element(s) can be removed from the group. It should be understood that, in general, where the disclosure, or aspects of the disclosure, is/are referred to as comprising particular elements and/or features, embodiments of the disclosure or aspects of the disclosure consist, or consist essentially of, such elements and/or features. For purposes of simplicity, those embodiments have not been specifically set forth in haec verba herein. Where ranges are given, endpoints are included. Furthermore, unless otherwise indicated or otherwise evident from the context and understanding of one of ordinary skill in the art, values that are expressed as ranges can assume any specific value or sub-range within the stated ranges in different embodiments of the disclosure, unless the context clearly dictates otherwise.

Those of ordinary skill in the art will recognize or be able to ascertain, using no more than routine experimentation, many equivalents to the specific embodiments of the disclosure described herein. Such equivalents are intended to be encompassed by the following claims.

1. A resin, comprising:
a first monomer;
a second monomer;
a photo-activated polymerization catalyst; and
a thermally activated foaming agent,
wherein the thermally activated foaming agent has a density within 20% of the density of the resin.

2. The resin according to claim 1, wherein the photo-activated polymerization catalyst comprises at least one of a radical-generating compound or a non-nucleophilic photo-base.

3. The resin according to claim 1, wherein the first monomer comprises two or more thiol groups.

4. The resin according to claim 3, wherein the first monomer comprises at least one of 2,2′-(ethylenedioxy) diethanethiol, 1,4-bis(3-mercaptobutyryloxy) butane, pentaerythritol tetrakis(3-mercaptobutylate), or 1,3,5,-tris(3-mercaptobutyryloxyethyl)-1,3,5,-triazine-2,4,6 (1H,3H,5H)-trione.

5. The resin according to claim 1, wherein the second monomer comprises two or more isocyanate groups.

6. The resin according to claim 1, wherein the second monomer comprises at least two double carbon-carbon bonds, at least two triple carbon-carbon bonds, or at least one each of a double carbon-carbon bond and a triple carbon-carbon bond.

7. The resin according to claim 1, wherein the second monomer comprises at least one methacrylate group.

8. The resin according to claim 7, wherein the second monomer comprises at least one of isobornyl methacrylate, tert-butyl methacrylate, 2-ethylhexyl methacrylate, isodecyl methacrylate, 2-hydroxyethyl methacrylate, lauryl methacrylate, or trimethylolpropane trimethacrylate.

9. The resin according to claim 1, wherein the second monomer comprises at least one acrylate group.

10. The resin according to claim 9, wherein the second monomer comprises at least one of isobornyl acrylate, 2-ethylhexyl acrylate, cyclic trimethylolpropane formal acrylate, hydroxypropyl acrylate, poly(propylene glycol) diacrylate, tricyclodecanedimethanol diacrylate, trimethylolpropane triacrylate, tri (propylene glycol) diacrylate, poly(ethylene glycol) diacrylate, Silmer OH ACR Di-400, CN1966, CN9002, CN9004, CN9028, CN9070, or CN9782.

11. The resin according to claim 1, wherein the second monomer comprises N,N′-methylenebis(acrylamide).

12. The resin according to claim 1, wherein the first monomer comprises an oligomer.

13. The resin according to claim 1, wherein the second monomer comprises an oligomer.

14. The resin according to claim 1, further comprising an oligomer.

15. The resin according to claim 1, wherein the resin has a viscosity ranging from 1 cP to 100,000 cP.

16. The resin according to claim 1, wherein the resin has a density ranging from 0.8 g/cm³ to 1.5 g/cm³.

17. The resin according to claim 1, wherein the thermally activated foaming agent comprises at least one microsphere comprising volatile hydrocarbons.

18. The resin according to claim 1, wherein the thermally activated foaming agent comprises at least one heat-expandable microsphere.

19. The resin according to claim 1, wherein the thermally activated foaming agent comprises Sekisui ADVANCELL EML 101.

20. The resin according to claim 1, wherein the thermally activated foaming agent has a density ranging from 1 g/cm³ to 1.2 g/cm³.

21. A method of preparing a photo-polymerized and foamed polymer material, the method comprising:
photo-polymerizing a resin according to claim 1 to obtain a photo-polymerized polymer material; and
heating the photo-polymerized polymer material at a heating temperature to obtain the photo-polymerized and foamed polymer material,
wherein:
the thermally activated foaming agent has a foaming onset temperature, and
the heating temperature is greater than or equal to the foaming onset temperature.

22-50. (canceled)

51. A polymeric structure having a macroscopic network geometry, wherein:
the macroscopic network geometry comprises a plurality of polymer links, each polymer link being joined to two or more polymer links, and
each polymer link comprises a foam.

52-63. (canceled)

64. A resin, comprising:
from about 3 pph to about 10 pph of a first monomer;
100 pph of a second monomer;
from about 0.9 pph to about 2.1 pph of a photo-activated polymerization catalyst; and
from about 5 pph to about 30 pph of a thermally activated foaming agent,
wherein the first monomer comprises two or more thiol groups,
wherein the second monomer comprises at least one of a methacrylate group, an acrylate group, or an acrylamide group, and
wherein pph is parts by mass per hundred parts of total mass of methacrylate, acrylate, and acrylamide compounds in the resin.

65-82. (canceled)
